(19) United States
(12) Patent Application Publication
(10) Pub. No.: US 2018/0244583 A1
(43) Pub. Date: Aug. 30, 2018

(54) CARBON FIBER-REINFORCED CARBIDE-CERAMIC COMPOSITE COMPONENT

(71) Applicant: SGL CARBON SE, Wiesbaden (DE)

(72) Inventors: MANFRED GOLLING, MEITINGEN (DE); THOMAS PUTZ, MEITINGEN (DE); KARL HINGST, MEITINGEN (DE); ANDREAS VELTEN, MEITINGEN (DE); SIMON DIETRICH, MEITINGEN (DE)

(21) Appl. No.: 15/966,183

(22) Filed: Apr. 30, 2018

Related U.S. Application Data
(63) Continuation of application No. PCT/EP2016/075827, filed on Oct. 26, 2016.

(30) Foreign Application Priority Data
Oct. 28, 2015 (DE) 102015221111.8

(51) Int. Cl. C04B 35/80; C04B 35/626; C04B 35/628; C04B 35/64; B32B 18/00

(52) U.S. Cl. CPC C04B 35/806; C04B 35/6269; C04B 35/62873; C04B 35/64; C04B 35/62878; C04B 35/62886; C04B 2235/77; C04B 2235/5248; C04B 2235/5268; C04B 2235/428; C04B 2235/3826; C04B 2235/616; C04B 2235/656; B32B 18/00

(57) ABSTRACT

A ceramic component is formed of at least one stack of two or more layers of one-directional non-woven carbon fiber fabrics embedded in a ceramic matrix containing silicon carbide and elemental silicon. All adjacent layers within the at least one stack directly adjoin each other. The at least one stack has a minimum thickness of 1.5 mm perpendicularly to the plane of the layers. The ceramic matrix permeates substantially the entire component.

### CROSS-REFERENCE TO RELATED APPLICATION

This is a continuation application, under 35 U.S.C. § 120, of copending international application No. PCT/EP2016/075827, filed Oct. 26, 2016, which designated the United States; this application also claims the priority, under 35 U.S.C. § 119, of German patent application No. 10 2015 221 111.8, filed Oct. 28, 2015; the prior applications are herewith incorporated by reference in their entirety.

### BACKGROUND OF THE INVENTION

### Field of the Invention

The present invention relates to a ceramic component containing unidirectional layers of carbon fibers, the layers lying, or stacked, one directly on top of the other in the component and forming a layered stack having a height, or thickness, of at least 1.5 mm. The present invention also relates to a method for producing the component and to the implementation of the component as a charging rack for treating goods at high temperatures.

Charging racks are needed to cure goods such as machine components or components for the automotive industry, for example, in which said goods are supported on a charging rack during the exposure to high temperatures. The requirements of the material of such charging racks are: high mechanical loading capacity (stiffness and strength), high temperature resistance and low weight. One material that is perfect according to these criteria is carbon fiber-reinforced carbon. Such charging racks are usually produced by unidirectional carbon fiber nonwovens, for example in the form of a prepreg, which are pre-impregnated with a resin, being laminated on top of one another, cured under increased pressure and temperature and then being subjected to pyrolysis, the cured resin being converted into carbon.

The unidirectional carbon fiber nonwovens consist of a continuous strip of closely lying, parallel continuous carbon fibers in this case (and also within the context of the present invention). Once a plurality of layers of the pre-impregnated carbon fiber nonwovens have been laminated and once the resin has been cured, a carbon fiber-reinforced polymer (CFRP) is produced, the cured resin forming the matrix of the CFRP. When the CFRP is pyrolyzed, usually at approximately 800° C., the polymer matrix disintegrates and volatile components contained therein escape. A carbon fiber-reinforced carbon (CFRC) is left.

However, CFRC charging racks are disadvantageous in that they are sensitive to oxidation and have a high open porosity. Such charging racks therefore have to be treated at high temperatures without oxygen. This is usually the case when used in industrial curing furnaces under a protective gas atmosphere or vacuum, in which the charge material, such as transmission gears, is cured. The charge material to be cured is, however, usually green-machined first of all, for example the teeth of transmission gears are milled. Residues such as cutting fluids or washing solutions then have to be removed from the charge material and said material is dried. For this purpose, the entire charge is heated to a maximum of 500° C. by means of a gas flame under normal atmospheric conditions, this process burning off said impurities. The charge material is then passed into the actual heat-treatment system or into the curing furnace. The charge material in both heat-treatment processes is preferably charged on the same charging rack, since changing the charging rack considerably increases process costs as the charge has to be cooled back down to a certain extent, transferred and then reheated in between the two processes.

However, due to said oxidation sensitivity of the CFRC, it is disadvantageous to continuously use CFRC charging racks during the preoxidation and subsequent heat-treatment and curing stages.

In addition, when cooling the charging rack and the charge material at the end of the heat-treatment process, these are lastly placed in cooling basins containing fluid (for example oil) if necessary. Quicker cooling rates are possible here in comparison with air cooling, however, the cooling medium penetrates the open porosity of the charging rack material. The medium is re-evaporated in the next curing cycle at the very latest, and therefore has a destructive effect on the material.

It is accordingly an object of the invention to provide a carbon-fiber reinforced carbide-ceramic composite which overcomes the above-mentioned and other disadvantages of the heretofore-known devices and methods of this general type and to provide an improved component, which can be used as a charging rack and which is more resistant to oxidation and simultaneously has a high mechanical loading capacity (stiffness and strength), high temperature resistance, a low weight and a small open porosity.

Silicon carbide (SiC)-ceramic components are known as oxidation-resistant components, for example. These can typically be produced by means of siliconizing a CFRC molded body with liquid, i.e. by liquid silicon infiltrating the CFRC. In this case, some of the carbon reacts with the elementary silicon to produce SiC. U.S. Pat. No. 7,186,360 B2 and its counterpart European patent EP 1 340 733 B1 describe SiC-ceramic composite materials for example, in which the reinforcing fibers (in particular carbon fibers) are oriented unidirectionally. The unidirectional reinforcing fibers are in the form of individual roving bundles in this case, which are at a certain distance from one another. The pore structure that is formed when the CFRP is carbonized to form the CFRC body is vital for subsequently siliconizing the molded body and forming the SiC matrix, since a suitable pore structure is the only way to ensure that the liquid silicon uniformly and sufficiently penetrates the CFRC body (cf. paragraph 6 of EP 1 340 733 B1). If the rovings of the reinforcing fibers are oriented in parallel without being fixed in the plane, carbonizing the binder resin leads to an unimpeded contraction in the direction perpendicular to the fiber orientation, such that the rovings in the CFRC shrink so as to lie very closely against one another and come to lie next to one another with a minimum open porosity percentage. This makes the liquid-siliconizing process more difficult, since the pore volume and the distribution of capillaries (microchannels) inside the material are unfavourably modified in comparison with that of CFRC preforms reinforced with short fibers or fabrics. According to the conventional technique, it has therefore so far not been possible to obtain satisfactory properties for C/SiC materials reinforced with unidirectional fibers (“UD fibers”) (cf. EP 1 340 733 B1, paragraph 8). The distance between the roving bundles in EP 1 340 733 B1 is therefore necessary for the liquid silicon to be able to fully infiltrate or impregnate the CFRC molded body.

Patent application publication US 2009/0239434 A1 and its counterpart German published patent application DE 10 2007 007 410 A1 also describe an SiC-ceramic composite material, in which the carbon fibers are oriented unidirectionally. Unidirectional carbon fiber nonwovens are processed in this case, similarly to in the above-described CFRC charging racks. However, due to the difficulties mentioned in U.S. Pat. No. 7,186,360 B2 and EP 1 340 733 B1, a certain spacer in the form of a coating or a system of wefts is provided between the unidirectional carbon fiber nonwovens in order to be able to carry out the final stage of fully liquid-siliconizing said component. The spacer preferably fully volatilizes during pyrolysis and thereby provides the pore structure required during the liquid-siliconizing process.

However, the solutions in the above-mentioned publications U.S. Pat. No. 7,186,360 B2 (EP 1 340 733 B1) and US 2009/0239434 A1 (DE 10 2007 007 410 A1) are disadvantageous in that, as a result of the distances between the rovings or nonwovens that are proposed in the two solutions, regions are present that are not reinforced by carbon fibers, as a result of which the component has to be correspondingly thicker, i.e. heavier.

For this reason too, the object of the present invention is directed to providing an improved component.

### SUMMARY OF THE INVENTION

With the foregoing and other objects in view there is provided, in accordance with the invention, a ceramic component, comprising:

a. at least one stack having at least two layers of unidirectional carbon fiber nonwoven embedded in a ceramic matrix containing silicon carbide and elementary silicon;

b. all mutually adjacent said layers within said at least one stack directly adjoining one another;

c. said at least one stack having a thickness of at least 1.5 mm in a direction perpendicular to a plane of said layers; and

d. said ceramic matrix substantially penetrating or permeating the ceramic component in its entirety.

Within the context of the present invention, it has been found that it has been possible for the first time to produce, under certain conditions, a carbide-ceramic component which comprises unidirectional carbon fiber nonwovens and in which the fibrous nonwovens can be stacked one directly on top of the other without being spaced apart at all, it being possible for the stack to have practically any desired thickness. Despite the tightly packed unidirectional carbon fibers, liquid silicon can fully infiltrate the CFRC preform.

The object of the present invention was therefore achieved by the provision of a ceramic component comprising at least one stack consisting of at least two layers of unidirectional carbon fiber nonwovens embedded in a ceramic matrix containing silicon carbide and elementary silicon, wherein all adjacent layers within the at least one stack directly adjoin one another, in that the at least one stack has a thickness of at least 1.5 mm in the direction perpendicular to the plane of the layers, and in that the ceramic matrix substantially penetrates the entire component.

Within the context of the present invention, the wording “in that all the adjacent layers within the at least one stack directly adjoin one another” should be understood to mean that the layers are not deliberately spaced apart, as in the methods in U.S. Pat. No. 7,186,360 B2 (EP 1 340 733 B1) and US 2009/0239434 A1 (DE 10 2007 007 410 A1). However, the present invention covers the fact that a matrix film is or can be provided between the layers or between the fibers of the adjoining layers, which matrix is practically always present when pre-impregnated layers of fibers are laminated one directly on top of the other.

As a result of the layers lying closely one on top of the other, the component according to the invention is characterized by increased strength. The component can therefore be designed to be thinner and thus altogether more light-weight for the particular application, for example as a charging rack. This makes it easier to handle said component and reduces the costs of using the charging rack, since it requires less energy to heat up due to the lower mass required.

The thickness or height of the stack of unidirectional carbon fiber nonwovens lying one directly on top of the other is not capped. Compared with US 2009/0239434 A1 (DE 10 2007 007 410 A1), according to which the layers of carbon fiber nonwovens, which are separated by spacers, each have a thickness of only approximately 0.1 mm (see the drawings of US 2009/0239434 A1 and DE 10 2007 007 410 A1), the thickness of the corresponding layers, or of the layered stack, according to the present invention is at least 1.5 mm. This cannot be achieved using the known methods. Said thickness is preferably at least 2.0 mm, and more preferably at least 2.5 mm. Most preferably, the layered stack inside the component is as thick as the entire component itself, according to the invention, i.e. the component preferably exclusively consists of a stack of layers of unidirectional carbon fiber nonwovens embedded in the ceramic matrix, which layers directly adjoin one another.

The thickness of the individual layers of unidirectional carbon fiber nonwovens is not particularly limited. It is possible for a layer to be so thin that it consists of just one monofilament layer, i.e. the thickness of the layer practically corresponds to the diameter of one carbon fiber, which is typically in the range of from 6 to 9 μm. When using such monofilament layers, the number of layers that lie one directly on top of the other according to the invention is such that the layered stack has a height of at least 1.5 mm. For particularly thick layers, for example thicker than 0.75 mm, the component may actually comprise just two layers, which lie one directly on top of the other according to the invention, and therefore the thickness of the stack is at least 1.5 mm.

Unidirectional carbon fiber nonwovens are usually obtained by one or more carbon fiber rovings being spread apart to a certain width. Carbon fiber rovings are bundles of continuous, parallel carbon fiber filaments that have not been twisted or intertwined. In this case, one or more 50K rovings are typically used. A 50K roving consists of approximately 50,000 individual filaments. These expanded slivers are, inter alia, pre-impregnated with a resin and available as prepregs. They typically have a thickness of approximately 0.25 mm. The method according to the invention described below can be carried out starting with prepregs of this type, for example.

In order to make the component suitable for high-temperature applications in an oxidative atmosphere, it is vital for the ceramic matrix to substantially penetrate or permeate the entire component. As will be discussed further in the following within the context of the method according to the invention, this means that the liquid silicon fully infiltrates the CFRC preform during the siliconizing process, and the carbon matrix of the CFRC preform is converted into SiC, at least in part. The component according to the invention is therefore considerably more resistant to oxidation than CFRC components that are only siliconized on the surface, for example, in which atmospheric oxygen penetrates the interior of said components over time, and gradually destroys the integrity and stability of the component.

The matrix preferably has a homogeneous composition across the entire component. However, this does not exclude the component being able to have a specific surface treatment that can also fully penetrate the matrix up to a specific depth of the surface. The composition of the structural components of the matrix, i.e. those responsible for its strength, is, however, preferably homogeneous. This leads to uniform homogeneous properties of the component, such as the strength and oxidation resistance thereof.

According to a preferred embodiment of the component according to the invention, consecutive layers within the at least one stack differ from one another in terms of the orientation of their fibers. For example, the layers can be situated one on top of the other such that their fiber orientation alternates between 0° and 90°, which is preferable since this variation leads to a considerable improvement in the stability of the component in the direction perpendicular to the 0° direction in comparison with a component in which all the unidirectional layers of fibers are only oriented in one direction, the 0° direction, while simultaneously only being slightly more complex to produce. A 0°/60°/120° sequence is also possible for consecutive layers. The type of variation of the fiber orientations of individual layers is not particularly limited and can be designed in accordance with the load profile of the component during subsequent use thereof.

The component according to the invention preferably has an open porosity of no more than 3.5%, more preferably no more than 3.0%. The smaller the open porosity of the component, the fewer the surfaces that are exposed to oxidative attacks. The open porosity can be reduced by the CFRC body being repressed one or more times using a liquid carbon supplier, for example. This process is described in more detail below as part of a preferred embodiment of the method according to the invention.

The component according to the invention preferably has a fiber volume ratio in the range of from 50-65%. The fiber volume ratio can be geometrically or optically determined on the basis of micrographs, for example. A high fiber volume ratio gives the component a correspondingly high modulus of elasticity. Such a high fiber volume ratio of carbon fibers in SiC-ceramic components, as in the preferred embodiment in which the thickness of the stack according to the invention corresponds to the thickness of the entire component, cannot be produced using the known methods. Even when the carbon fiber nonwovens are tightly pressed against one another, the fiber volume ratio is lower than in fabrics, since gaps that are not filled with fibers inevitably exist within a fabric.

According to a simple embodiment of the component according to the invention, said component is a plate, in the plane of which the fibrous nonwovens are oriented. More complex embodiments of the present invention are preferably assembled from individual plate-shaped components of this type. As described below as part of a preferred method according to the invention, this assembly process take place before the siliconizing process. The component, which is interlockingly assembled in the graphitized CFRC state, is then siliconized as a whole. In this case, the components are integrally and irreversibly connected to one another at the connecting points. A preferred embodiment of the present invention therefore relates to a ceramic component comprising at least two components that are integrally bonded to one another, the at least two components also each being formed as a ceramic component according to the invention.

The integral bond between the boundary surfaces of the interconnected components of the ceramic component preferably comprises elementary silicon. The interlockingly connected CFRC components can, however, also be provided with an adhesive connection. In this case, the adhesive can preferably be carbonized and can therefore be converted into carbon when the assembled component is siliconized as it is heated. Due to its porosity, this carbon guides the liquid silicon from one component of the two connected components to the other. The resultant ceramic component therefore also comprises SiC in addition to the elementary silicon at the integral bond between the boundary surfaces of the interconnected components. This technique for bonding and joining materials to be siliconized is known and is described in US 2014/0044979 A1 and in DE 10 2011 007 815 A1, for example. The type of adhesive and fillers contained therein, for example, is not particularly limited.

In an oxidation test carried out in air at 400° C. for 1 hour, the component according to the invention preferably has an oxidative weight loss of no more than 0.05%, more preferably 0.03%.

The component according to the invention preferably has a modulus of elasticity of at least 60 GPa. The component according to the invention preferably has a strength of at least 190 MPa. It is well known that the modulus of elasticity and the strength are determined in the 3-point bend test according to current test standard EN658-3. In assembled components, these parameters of course also only apply to the individual, homogeneous components that are not interrupted by joints.

The component according to the invention preferably has a density of no more than 2.0 g/cm³. This low density stems from the comparatively high carbon content, which in turn results from the high fiber volume ratio. The carbon fibers in the component therefore remain virtually intact and are only slightly attacked by silicon and converted into SiC. The low density is in particular advantageous for use in charging racks, since a lower density is also associated with a lower heat capacity, which decreases the energy costs during use.

With the above and other objects in view there is also provided, in accordance with the invention, a method for producing a ceramic component. The method comprises the following steps:

a) placing at least two unidirectional carbon fiber nonwovens, which are impregnated with a polymer or a polymer precursor, one directly on top of the other,

b) consolidating the carbon fiber nonwovens, which are placed one on top of the other, under increased pressure and increased temperature, and obtaining a carbon fiber-reinforced polymer,

c) carbonizing the carbon fiber-reinforced polymer at a temperature of between 600° C. and 1000° C., and obtaining a carbon fiber-reinforced carbon,

d) graphitizing the carbon fiber-reinforced carbon at a temperature of at least 1800° C., and

e) siliconizing the carbon fiber-reinforced polymer that is graphitized in step d), said carbon being siliconized in such a way that, on a surface of the graphitized, carbon fiber-reinforced carbon, which surface is in contact with liquid silicon, the ends of at least some of the carbon fibers of at least one of the carbon fiber nonwovens point towards said surface.

The above-described component according to the invention is preferably produced using the method according to the invention. All the features mentioned in connection with the component according to the invention therefore correspondingly also apply to the method, and vice versa.

The expression “lying one directly on top of the other” is understood to mean that the impregnated unidirectional carbon fiber nonwovens are placed one directly on top of the other, i.e. without anything being provided therebetween. As described above in connection with U.S. Pat. No. 7,186,360 B2 (EP 1 340 733 B1) and US 2009/0239434 A1 (DE 10 2007 007 410 A1), it is not readily possible to liquid-siliconize CFRC bodies that contain unidirectional carbon fiber nonwovens, since the pore structure of the tightly packed carbon fibers in the nonwoven is insufficient for the liquid silicon to be able to penetrate the body. Within the context of the present invention, measures have been found that make it possible for the liquid silicon to fully penetrate the body.

The process of graphitizing the CFRC body, as mentioned in step d), has a defining influence on the formation of a suitable pore system in the CFRC body. At the graphitizing temperature of 1800° C. and higher, the carbon fiber undergoes a specific change in its geometry: it becomes shorter and simultaneously thicker, i.e. the carbon fiber shrinks in the fiber direction and expands in the direction perpendicular thereto. This expansion leads to the formation of channels along the carbon fibers after cooling, which are suitable for the siliconizing process. In practice, the graphitizing process can also take place in one step together with the preceding carbonizing process, without having to be cooled back down in between, i.e. the body to be carbonized and graphitized can reach the chosen graphitizing temperature in one step.

In order to now allow the silicon to reach these channels, according to the invention the graphitized CFRC body is brought into contact with liquid silicon when it is liquid-siliconized such that the ends of at least some of the carbon fibers of the graphitized, carbon fiber-reinforced carbon point towards the surface in contact with the liquid silicon. The precise angle at which these carbon fibers face the contact surface is not particularly limited here, i.e. they can also face the contact surface at an angle. In order to express this more clearly, for example in plate-shaped components according to the invention in which the fibers of the nonwoven are oriented at 0°/90°, any edge surface of the corresponding CFRC plate can be siliconized. It has become apparent that, once the silicon has found its way into the interior of the preform, said preform is completely impregnated. In contrast, the siliconizing process is made more difficult when the plate-shaped preform mentioned by way of example is intended to be siliconized across its large surface that is parallel to the nonwovens, for example by being placed on wicks.

The polymer mentioned in step a) or the polymer precursor is not particularly limited. It may be a solution, a molten material or a synthetic resin powder, thermoplastics or the precursors thereof in this case, with synthetic resins being preferred since they can usually be transformed to form dimensionally stable thermosetting polymers. Suitable and therefore preferred synthetic resins are phenolic resin, furan resin and cyanate ester. According to a preferred embodiment, the polymer or polymer precursor therefore comprises a synthetic resin selected from the group consisting of phenolic resin, furan resin and cyanate ester. A thermoplastic that can be carbonized is used as a preferred thermoplastic. In this case, a “thermoplastic that can be carbonized” denotes a thermoplastic that forms a carbon residue when heated to a temperature of at least 800° C. in the absence of oxidizing materials, the mass of which is at least 20% of the mass (in solutions, the dry mass) of the thermoplastic used.

The term “consolidating” as per step b) can be understood to mean that the impregnated carbon fiber nonwovens that lie one on top of the other are solidified to form a CFRP body. In thermosetting polymer precursors, such as phenolic resins, furan resins or cyanate esters, the consolidation step involves curing the synthetic resin. In thermoplastics, the consolidation step involves connecting the layers to one another by melting the thermoplastics.

According to a preferred embodiment of the present invention, the carbon fiber-reinforced carbon according to step c) is post-treated at least once, which comprises the following steps:

C1) impregnating the carbon fiber-reinforced carbon with a liquid carbon supplier, and

C2) carbonizing the impregnated carbon fiber-reinforced carbon according to step c).

The term “carbon supplier” should be understood to mean any liquid substance in which carbon is left over after the pyrolysis or carbonizing process. Furthermore, within the context of the present invention, the terms “pyrolysis” and “carbonizing” can be understood to be synonyms. Preferred carbon suppliers are pitch, phenolic resin and furfuryl alcohol, since these have a high carbon yield.

According to a preferred embodiment of the present invention, the unidirectional carbon fiber nonwoven, which is impregnated with a polymer or a polymer precursor, is a prepreg selected from the group consisting of a phenolic resin prepreg, a furan resin prepreg and a cyanate ester prepreg. These are characterised by advantageous handling when they are laminated on top of one another, and form dimensionally stable CFRP bodies.

When using a synthetic resin and in particular a prepreg, consolidating the carbon fiber nonwovens placed one on top of the other involves curing the synthetic resin.

According to a preferred embodiment of the present invention, the graphitized, carbon fiber-reinforced carbon is mechanically processed in accordance with the desired shape of the ceramic component, thereby producing a molded body. Within the context of the present invention, the molded body is understood to be the mechanically processed graphitized CFRC body before it is siliconized. The mechanical processing of a CFRC body is considerably less complex than the mechanical processing of the considerably harder siliconized component.

According to a preferred embodiment of the present invention, at least two molded bodies are interlockingly connected such that, on both molded bodies, on the respective boundary surfaces of said connected molded bodies, which surfaces are in contact with one another, the ends of at least some of the carbon fibers of at least one of the carbon fiber nonwovens point towards said boundary surfaces. This contributes to the more effective transition of the silicon from one component to the other. In this case, the expression “the ends of” has the same meaning as defined above in connection with the component according to the invention. Components joined in this way are monolithic and therefore do not have to be connected by means of additional complex connecting elements, such as springs, clamps, etc. In a preferred variant of this embodiment, joints are made on one of the two long edges of individual elongate plates, the width of which joints corresponds to the thickness of a plate. These joints point inwards at a right angle, away from the edge of the plate right up to the centre or the longitudinal axis of the plate. The plates joined in this way are then assembled to form a chequerboard-like grating, similar to a log cabin construction. The entire grating can then be siliconized. This example shows that it is not necessary to provide fibers having ends that end at the boundary surface over the entire boundary surface of a component that is in contact with another component. Instead, it is sufficient to provide the fibers having ends that end at the boundary surface only in regions of the boundary surface, the corresponding regions of the components to be connected having to be in contact with one another, at least in part.

Another aspect of the present invention relates to the use of the ceramic component according to the invention as a charging rack, preferably as a charging rack in high temperature applications (at least 500° C.) and more preferably in the presence of atmospheric oxygen. The present invention, or the component according to the invention, has already been extensively described above with regard to this advantageous use, with reference hereby being made thereto in order to avoid repetition.

The present invention will be illustrated in the following by means of specific examples.

### EXAMPLES

20 layers of a UD prepreg were placed one directly on top of the other such that their orientations alternated in a 90° offset (i.e., 0°/90°). In this case, the UD prepreg consists of parallel carbon fibers that are impregnated with phenolic resin that has not yet been cured. According to the invention, the prepreg comprises absolutely no auxiliary threads or other components in the direction transverse to the fiber direction of the carbon fibers. One layer of this prepreg has a height or thickness of approximately 0.25 mm and a width of approximately 1.20 m. The laminate is cured in a flat press mold under 1 bar and at 140° C. for 8 hours. Any escaping resin is removed from the surface of the resultant CFRP plate and said plate is cut to size to form smaller test specimens having the dimensions 10 cm×10 cm.

The CFRP plates are carbonized at 900° C. under protective gas (nitrogen). A test specimen of the carbonized plate was subjected to the following repressing procedure twice (example 1), and another test specimen was subjected to the following repressing procedure three times (example 2):

impregnating with pitch, and

re-carbonizing (900° C.).

The test specimens in example 1 and example 2 were then graphitized for 24 hours at approximately 2000° C. The graphitized CFRC test specimens were placed in a siliconizing chamber and siliconized at approximately 1700° C. In this case, the test specimens are inserted into a rack made of graphite, which is arranged in a graphite crucible containing a sufficient amount of silicon powder for the siliconizing process. In this case, the graphite rack ensures that the component is oriented relative to the silicon bath surface as per the invention, i.e. one edge of the plates is in contact with the Si melt during the siliconizing process, since the ends of some of the carbon fibers end at the edges.

| | Test specimen | Test specimen |
|---|---|---|
| | example 1 | example 2 |
| AD (g/cm³) | 1.90 | 1.80 |
| Open porosity | 2% | 3% |
| Si content | 10% | 8% |
| C content | 66% | 71% |
| SiC content | 24% | 21% |
| Modulus of elasticity (GPa) | 60 | 65 |

AD: density determined according to the Archimedes principle using water.
Open porosity: was also measured by being determined according to the Archimedes principle.
Si content: free silicon not bound to carbon.
C content: free carbon not bound to silicon.

An oxidation test was carried out for the test specimen according to example 2. A weight loss of approximately 0.15% was identified over 8 hours at 400° C. in air, which corresponds to a weight loss per hour of approximately 0.02%.

In both test specimens, the enormously high content of free carbon is evident, which results from the high fiber volume ratio. This ultimately leads to a high modulus of elasticity and a low density, which, in combination with low oxidation sensitivity, surpasses the known ceramic materials. Furthermore, it is evident that an additional repressing process as per example 2 resulted in a higher modulus of elasticity. This is presumably because the carbon fibers are even better protected as a result, and therefore more of the fibers are preserved. The C content or SiC content in example 2 also indicates this.

The above description makes reference to several published documents. As far as they provide additional or supplementary information, they are herewith incorporated by reference.

1. A ceramic component, comprising:
at least one stack having at least two layers of unidirectional carbon fiber nonwoven embedded in a ceramic matrix containing silicon carbide and elementary silicon;
all mutually adjacent said layers within said at least one stack directly adjoining one another;
said at least one stack having a thickness of at least 1.5 mm in a direction perpendicular to a plane of said layers; and
said ceramic matrix substantially penetrating the ceramic component in its entirety.

2. The ceramic component according to claim 1, wherein said ceramic matrix has a homogeneous composition across the entire component.

3. The ceramic component according to claim 1, wherein consecutive said layers within said at least one stack differ from one another in terms of an orientation of carbon fibers thereof.

4. The ceramic component according to claim 1, wherein the component has an open porosity of no more than 3.5%.

5. The ceramic component according to claim 1, wherein the component has a fiber volume in a range of 50-65% of a volume of the component.

6. The ceramic component according to claim 1, wherein the component has a density of no more than 2.0 g/cm³.

7. The ceramic component according to claim 1, configured as a charging rack.

8. A composite component, comprising at least two ceramic components according to claim 1 integrally bonded to one another.

9. A method of producing a ceramic component, the method comprising the following steps:
a) placing at least two unidirectional carbon fiber nonwovens, which are impregnated with a polymer or a polymer precursor, one directly on top of another;
b) consolidating the carbon fiber nonwovens, which are placed one on top of the other, under increased pressure and increased temperature relative to ambient pressure and temperature to form a carbon fiber-reinforced plastic;
c) carbonizing the carbon fiber-reinforced plastic at a temperature of between 600° C. and 1000° C. to form a carbon fiber-reinforced carbon;
d) graphitizing the carbon fiber-reinforced carbon at a temperature of at least 1800° C. to form a graphitized carbon fiber-reinforced carbon; and
e) siliconizing the graphitized carbon fiber-reinforced carbon in such a way that, on a surface of the graphitized carbon fiber-reinforced carbon that is in contact with liquid silicon, at least some of the carbon fibers at a face end of at least one of the carbon fiber nonwovens point towards said surface.

10. The method according to claim 9, which comprises post-treating the carbon fiber-reinforced carbon formed in step c) at least once by performing the following steps:
C1) impregnating the carbon fiber-reinforced carbon with a liquid carbon supplier to form an impregnated carbon fiber-reinforced carbon; and
C2) carbonizing the impregnated carbon fiber-reinforced carbon.

11. The method according to claim 9, wherein the polymer or the polymer precursor comprises a synthetic resin selected from the group consisting of phenolic resin, furan resin and cyanate ester.

12. The method according to claim 9, wherein the unidirectional carbon fiber nonwoven impregnated with a polymer or a polymer precursor is a prepreg selected from the group consisting of a phenolic resin prepreg, a furan resin prepreg and a cyanate ester prepreg.

13. The method according to claim 9, wherein the step of consolidating the carbon fiber nonwoven placed one on top of the other comprises curing the synthetic resin.

14. The method according to claim 9, which comprises mechanically processing the graphitized, carbon fiber-reinforced carbon in accordance with a desired shape of the ceramic component, thereby producing a molded body.

15. The method according to claim 14, which comprises interlocking at least two molded bodies such that, on respective boundary surfaces of the connected molded bodies that are in contact with one another, ends of at least some of the carbon fibers of the corresponding molded bodies point towards the boundary surfaces.

16. The method according to claim 9, which comprises forming the ceramic component as a charging rack.
